(19) United States
(12) Patent Application Publication
(10) Pub. No.: US 2015/0205766 A1
(43) Pub. Date: Jul. 23, 2015

(54) SERVING COMBINED RESOURCES TO A BROWSER CLIENT

(71) Applicant: Reinaldo Javier Aguiar Marcano, Santa Clara, CA (US)

(72) Inventor: Reinaldo Javier Aguiar Marcano, Santa Clara, CA (US)

(73) Assignee: GOOGLE INC., Mountain View, CA (US)

(21) Appl. No.: 13/415,486

(22) Filed: Mar. 8, 2012

(51) Int. Cl. G06F 17/22; G06F 17/30; H04L 29/08

(52) U.S. Cl. CPC G06F 17/227; G06F 17/2247; H04L 67/32; G06F 17/30864

(57) ABSTRACT

In serving combined resources from a server computer to a browser client, a server computer retrieves an individual document that includes multiple requests for resources. The server computer generates a modified individual document by using a server-generated Uniform Resource Locator (URL) to represent the multiple requests for resources in the individual document. The server computer sends, to the browser client, the modified individual document. The server computer receives, from the browser client, a request matching the server-generated URL. The server computer generates a combined resource set in response to receiving the request matching the server-generated URL. The server computer sends, to the browser client, the combined resource.

### BACKGROUND

A web browser enables a user to access, retrieve and view documents and other resources on the Internet. A web browser may be configured to fetch, from a server, resources in individual requests. The web browser initiates the requests by receiving activation of a web browser feature. For example, a user may press a hyperlink that initiates a request for a document. A server receives the request for a document and fetches the document to respond to the request. The server then serves the document to the web browser.

### SUMMARY

A technology is provided for serving combined resources from a server computer to a browser client. For example, a method comprises the following: retrieving, at the server computer, an individual document that includes multiple requests for resources, wherein the multiple requests include at least a request for a first resource and a request for a second resource; generating a modified individual document by using a server-generated Uniform Resource Locator (URL) to represent the multiple requests for resources in the individual document; sending, to the browser client, the modified individual document; receiving, from the browser client, a request matching the server-generated URL; generating a combined resource in response to receiving the request matching the server-generated URL, wherein the combined resource includes at least the first resource and the second resource; and sending, to the browser client, the combined resource.

Generating the combined resource may comprise the following: selecting an unreserved variable of the first resource to be a selected variable of the first resource, and attaching the second resource to the selected variable of the first resource.

The technology encompasses other implementations configured as set forth above and with other features and alternatives. This summary is not intended to identify key features or essential features of the claimed subject matter, nor is it intended to be used as an aid in determining the scope of the claimed subject matter.

### BRIEF DESCRIPTION OF THE DRAWINGS

Implementations described herein will be readily understood by the following detailed description in conjunction with the accompanying drawings.

FIG. 1 is a conceptual diagram of a system for serving uncombined resources from a server computer to a browser client;

FIG. 2 is a block diagram of a system for serving combined resources from a server computer to a browser client;

FIG. 3 is a flowchart of a method for serving a combined resource from a server computer to a browser client;

FIG. 4 is a schematic diagram of a method for combining resources before sending the combined resource from a server computer to a browser client;

FIG. 5 is a schematic diagram of another method for combining resources before sending the combined resource from a server computer to a browser client;

FIG. 6 is a conceptual diagram of a system for serving combined resources from a server computer to a browser client;

FIG. 7 is a block diagram of a general purpose or special purpose computer system.

### DETAILED DESCRIPTION

Browser clients have a limited number of connections for receiving resources. Separately serving resources, to a browser client, results in a slowed user experience at the browser client. It is common for a user of a conventional browser client to wait for downloaded resources to appear when loading a web page. Fortunately, the technology described herein addresses the problems associated with separately serving resources to a browser client, and a slowed user experience at the browser client, by serving combined resources. The present technology helps speed up rendering processes at the browser client by combining at least one resource with another resource so that the combined resource can be delivered to the client in one response. Further, the combined resource can be loaded at the browser client simultaneously. The served combined resource effectively speeds up a user experience at the browser client. For example, the time is decreased between activation of a browser client feature (e.g., a hyperlink) and the browser client executing a fetched resource.

### Serving Uncombined Resources

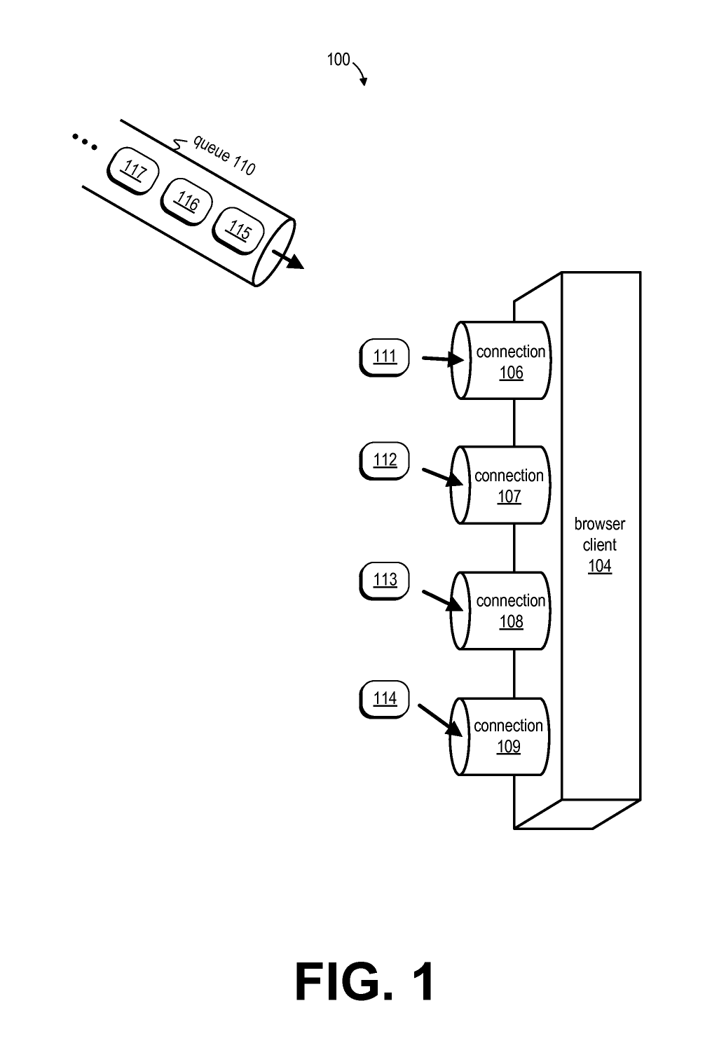

FIG. 1 is a conceptual diagram of a system 100 for serving uncombined resources from a server computer 102 to a browser client 104. The browser client 104 is configured to receive only one resource through one connection at one time. Likewise, the server 102 is configured to send resources to the browser client 104 through one connection at one time.

The browser client 104 has a limitation on the number of connections the browser client 104 may establish simultaneously. In this example, the browser client 104 has a limit of four connections that the browser client 104 may establish at the same time. The browser client 104 receives a resource 111 via connection 106, a resource 112 via connection 107, a resource 113 via connection 108, and a resource 114 via connection 109. Each resource shown may include, for example, one JavaScript™ file, one CSS (Cascading Style Sheet) file, or another type of resource.

The limited connections lead to the browser client 104 causing resources to be placed into a queue 110 to wait to be executed. For example, the browser client 104 causes at least a resource 115, a resource 116, and a resource 117 to be placed in the queue 110.

When the browser client 104 has the next available connection, the browser client 104 may download the next resource in the queue 110 through that available connection. In this example, the next resource in the queue 110 is resource 115. The connections do not necessarily finish downloading in order. For example, any given connection 106, 107, 108, or 109 may complete a download before any other connection finishes. Once the browser client 104 finishes downloading all the resources for a given document (e.g. HTML document), the browser client 104 may execute (e.g., display) the given document.

Further, some resources may expressly block the browser client 104 from rendering other resources until the browser client 104 has fully downloaded the resource that is doing the blocking. For example, resource 111 may include a JavaScript™ file, while resources 112, 113, and 114 may each include CSS files for an HTML (Hypertext Markup Language) document; the resource 111 (e.g., JavaScript™ file) may block the browser client 104 from rendering the other resources until the browser client 104 has fully downloaded the resource 111.

Unfortunately, the clogged queue 110 and the separately served resources effectively slow down a user experience at the browser client 104. For example, the time is extended between activation of a browser client feature (e.g., a hyperlink) and execution of the fetched resources (e.g., JavaScript™ files and CSS files).

### Serving Combined Resources

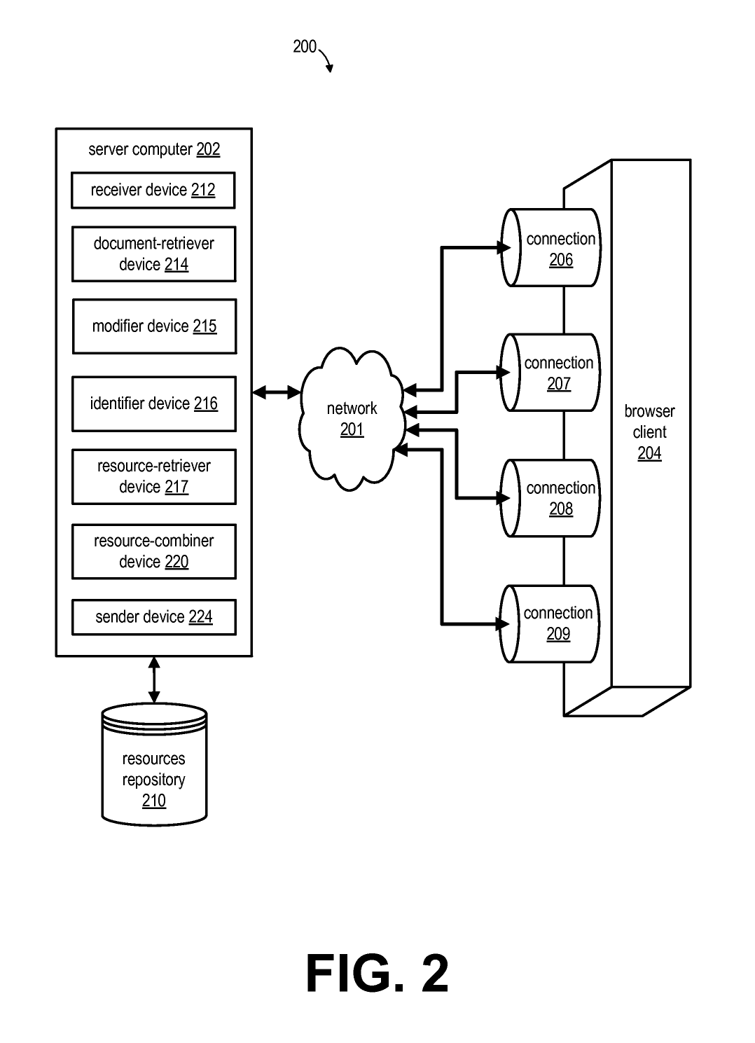

FIG. 2 is a block diagram of a system 200 for serving combined resources from a server computer 202 to a browser client 204. The server computer 202 includes one or more devices that provide services to other computers and/or computer programs. The server computer 202 may include without limitation a receiver device 212, a document-retriever device 214, a modifier device 215, an identifier device 216, a resource-retriever device 217, a reserved-combiner device 220, and/or a sender device 224. The devices of the server computer 202 are coupled together.

A browser client 204 (e.g., browser, Web browser, Internet browser, network browser, etc.) may include a device or multiple couple devices that can display graphics, text, or both, from Web pages, Internet pages, or other network pages. A device (e.g., apparatus or machine) is hardware or a combination of hardware and software. Examples of a browser client include without limitation Internet Explorer™, Firefox™ and Safari™. A Web (e.g., the Web, the Internet) may include a global system of interconnected computer networks that use a standard Internet protocol (e.g., TCP/IP) to serve billions of users worldwide.

In some implementations, the server computer 202 is coupled to the browser client 204 by way of a network 201. The network 201 may include, for example, the Web, the Internet, a local area network, a wide area network, a network of networks, a wireless network, and/or a cellular network. In another implementation, the server may be located locally to the browser client 204, for example, within the same computer where the browser client is located.

The server computer 202 is coupled to, or includes, a resources repository 210. The server computer 202 may include without limitation a server system that includes without limitation a Web server, an application server, and/or a database server. The resources repository 210 includes a database or memory for storing and/or managing resources. A resource may include a script, a document, and/or a file. A script (e.g., HTML script, JavaScript™, CSS script, code, source code, etc.) may include a list of commands that are executable at a browser client, a user device and/or a computer. Examples of a resource include without limitation a Markup document (e.g., HTML document, XML document, etc.), a Stylesheet (e.g., CSS file), a JavaScript™ file, and an image (e.g., JPEG image, GIF image, PNG image, etc.). A database may include a collection of data organized and stored in a memory in such a way that a computer program may quickly retrieve, fetch and/or select desired pieces of the data.

The browser client 204 enables a user to access, retrieve and view documents and/or other resources on a network 201 (e.g., the Internet). The browser client 204 may fetch, from the server computer 202, resources in individual HTTP (Hypertext Transfer Protocol) requests. The browser client 204 initiates the HTTP requests by receiving activation of a browser client 204 feature. For example, a user may press a hyperlink that initiates an HTTP request for a document. The browser client 204 is configured to send the request to the server computer 202.

The receiver device 212 of the server computer 202 is configured to receive the HTTP request for the document. The document-retriever device 214 is configured to retrieve (e.g., call, fetch, access, select, and/or obtain, etc.) an individual document (e.g., HTML document). The modifier device 215 is configured to generate a modified individual document from the individual document. The identifier device 216 is configured to identify a request for resources referenced by the individual document. The resource-retriever device 217 is configured to retrieve, call, fetch, access, and/or obtain the requested resources. The resource-combiner device 220 is configured to generate a combined resource including requested resources. The sender device 224 is configured to send, among other things, the combined resource to the browser client 204. In contrast, a conventional server computer is typically configured to send resources separately (e.g., a JavaScript™ file separate from a CSS file) because of how a browser interprets resources.

The browser client 204 is further configured to receive, among other things, a combined resource from the server computer 202 via one or more connections. In this example, the browser client 204 may receive a combined resource via four connections (e.g., an open HTTP connection). The connections in this example include a connection 206, a connection 207, a connection 208, and a connection 209. Likewise, the server computer 202 is configured to communicate with the browser client 204 via the connections 206, 207, 208, and/or 209.

It will be readily appreciated that the schematic of FIG. 2 is for explanatory purposes, and that numerous variations are possible. For example, the system 200 may include without limitation a database (or system of databases) arranged in a configuration that is different than the resources repository 210 depicted here. Other configurations exist as well.

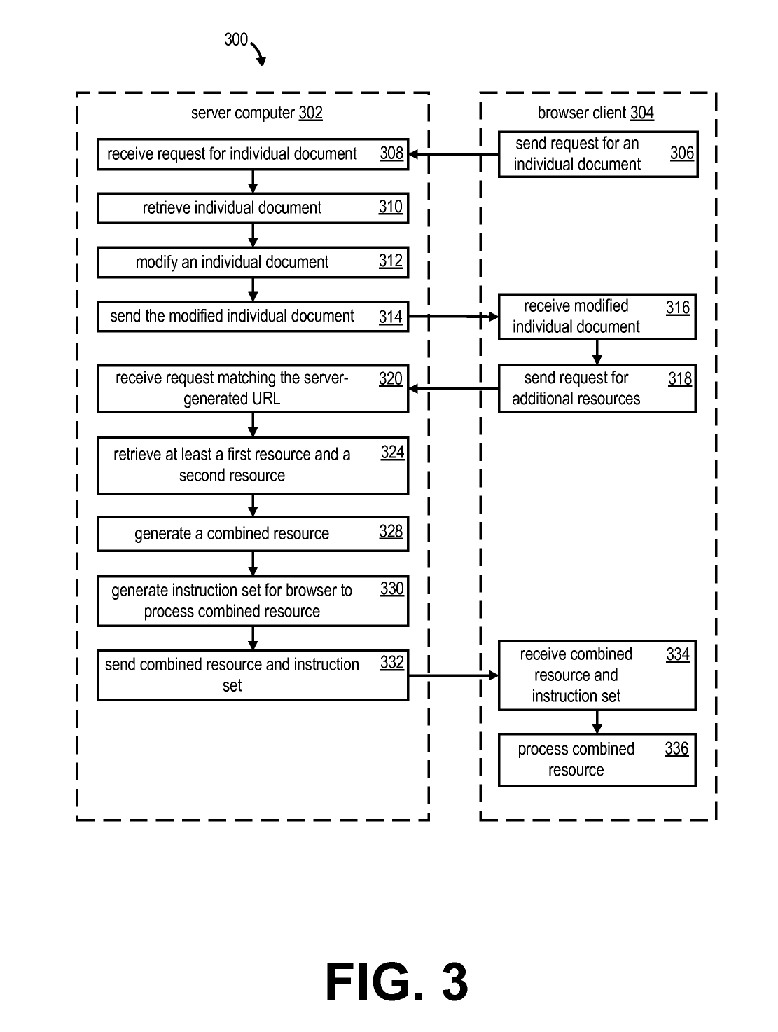

FIG. 3 is a flowchart of a method 300 for serving a combined resource from a server computer 302 to a browser client 304. In some implementations, the system 200 of FIG. 2 may carry out this method 300 of FIG. 3.

In an act 306, the browser client 304 sends to a server computer 302 a request for a document. For example, the browser client 304 may be configured to receive an activation of a hyperlink that initiates an HTTP request for an HTML document. The browser client 304 may also be configured to cause the client computer to send over the Internet the HTTP request to the server computer 302, which manages resources including the requested HTML document.

In an act 308, the server computer 302 receives the request for the individual document. In an act 310, the server computer 302 retrieves, fetches, and/or selects the individual document. The individual document happens to include multiple requests for resources. Table 1 below provides an example of an individual document that the server computer 302 may retrieve:

TABLE 1
Example of an Individual Document

```
<html>
<head>
    <link REL=StyleSheet href=“/some-relative-URL-stylesheet.css”/>
    <link REL=StyleSheet href=“/some-other-relative-URL-
    stylesheet.css”/>
    <script src=“/some-relative-URL-script.js”></script>
    <script src=“/some-other-relative-URL-script.js”><x/script>
</head>
<body>
    {.... document body }
</body>
</html>
```

In an act 312, before the server computer 302 serves the individual document, the server computer 302 modifies the individual document by using one resource request to represent the multiple requests for resources. For example, the server computer 302 may add a server-generated URL, a JavaScript™, and/or other code to a header of the HTML document in order to represent, in one request, the multiple requests in Table 1. The modification enables the server computer 302 to identify a future request for resources as belonging to the individual document. Table 2 below provides an example of a modified individual document:

TABLE 2
Example of a Modified Individual Document

```
<html>
<head>
    <script src=“/URL-generated-by-the-server.js”></script>
</head>
<body>
    {.... document body }
</body>
</html>
```

In the example of Table 2, the modified individual document includes a server-generated URL (e.g., “URL-generated-by-the-server.js” in Table 2) that has a pattern for which the server computer 302 may actively listen. The server-generated URL contains enough information to allow the server computer 302 to identify the resources the server computer 302 is supposed to combine (e.g., the two CSS resources and the two JavaScript™ resources in Table 1). Note the server computer 302 can encrypt the information in the server-generated URL if the information includes sensitive data.

In an act 314, the server computer 302 sends the modified individual document to the browser client 304. The server computer 302 actively listens for URLs matching the pattern for the server-generated URL (e.g., “URL-generated-by-the-server.js” in Table 2).

In an act 316, the browser client 304 receives the modified individual document from the server computer 302, reads the modified individual document, and determines that the document calls for additional resources according to the server-generated URL (e.g., “URL-generated-by-the-server.js” in Table 2).

In an act 318, the browser client 304 sends to the server computer 302 requests for resources by using the server-generated URL (e.g., “URL-generated-by-the-server.js” in Table 2). As described above, the server 302 is actively waiting.

In an act 320, the server computer 302 receives, from the browser client 304, the request matching the server-generated URL (e.g., “URL-generated-by-the-server.js” in Table 2). Actively listening, the server computer 302 is able to identify that multiple resources should be combined. The example of Table 1 shows four resources that the server computer 302 may combine (e.g., two CSS resources and two JavaScript™ resources).

In an act 324, the server computer 302 retrieves at least a first resource and a second resource. For example, the server computer 302 may retrieve a JavaScript™ file from a resources repository (e.g., a database that manages JavaScript™ files), and may retrieve a CSS file from another repository or from the same repository containing the JavaScript™ file.

In an act 328, the server computer 302 generates a combined resource. For example, the server computer 302 may find, generate, and/or select an unreserved variable of the first resource. An unreserved variable is a variable that is not already in use, for example, in a JavaScript™ file. That unreserved variable becomes the selected variable of the first resource. Generally, the server computer 302 is configured to use any reasonable technique for avoiding a variable name collision in the first resource. The server computer 302 may attach (e.g., store) the second resource in the selected variable of the first resource. Table 3 below provides an example of how the server computer 302 may attach (e.g., store) a CSS file as text to a selected variable of a JavaScript™ file:

TABLE 3
Example Storage of a Resource in a Variable or another Resource

// Store CSS content into a JavaScript ™ variable
var unused_js_variable = ‘.myCSSCIass { color: blue; }’;

In this example, the combining of the resources occurs during a runtime of the fetch request from the browser client 304 (e.g., after the server computer 302 receives the URL request matching the server-generated URL).

In an act 330, the server computer 302 generates an instruction set that instructs the browser client 304 to process the combined resource. The instruction set may include, for example, a JavaScript™ code and/or an HTML document that instructs the browser client 304 to process the second resource along with the first resource. For instance, the instruction set may instruct the browser client 304 to remove the CSS content from the variable and include the CSS file in a DOM (Document Object Model) of the HTML file that the browser client 304 received in the step 316 above. Table 4 below provides an example of an instruct set for the browser:

TABLE 4
Example Instruction Set for Browser to Process Combined Resource

```
// Insert CSS content into the DOM
var head = document.getElementsByTagName(‘head’)[0];
style = document.createElement(‘style’),
rules = document.createTextNode(css_content);
style.type = ‘text/css’;
if(style.styleSheet) {
    style.styleSheet.cssText = rules.nodeValue;
} else {
    style.appendChild(rules);
}
head.appendChild(style);
```

Alternatively, any combination of the acts 324, 328 and 330 may occur before the act 320. For example, the server computer 302 may pre-fetch the resources, pre-combine the resources and/or pre-generate an instructions set before the server computer 302 even receives the URL request matching the server-generated URL. Accordingly, this alternative may further speed up the serving of the resources to the browser client 304.

In an act 332, the server computer 302 then sends to the browser client 304 the combined resource and the instruction set. Note that a conventional method here was to send each resource separately (e.g., separate first resource, separate second resource, and separate any other resource) to the browser client 304.

In an act 334, the browser client 304 receives the combined resource and the instruction set. Rather than receiving separately the multiple resources via multiple different connections (e.g., HTTP connections), the browser client 304 receives the combined resource and the instruction set via one connection.

In an act 336, the browser client 304 processes the combined resource in accordance with the instruction set. For example, the browser client 304 may remove a CSS file from the variable of a JavaScript™ file, may generate a style tag (e.g., style note) in a DOM of the downloaded HTML document, and may insert the CSS file at the style tag in the DOM. The browser client 304 may then interpret the CSS file in a substantially same manner as if the CSS file had been downloaded separately outside of the combined resource. Meanwhile, the browser client 304 does not have to download completely the first resource (e.g., JavaScript™ file) before the browser client 304 begins rendering the second resource (e.g., CSS file). Likewise, the server computer 302 does not have to send completely the first resource (e.g., JavaScript™ file) before the browser client 304 begins rendering the second resource (e.g., CSS file).

Accordingly, the serving of the combined resource speeds up the user experience at the browser client 304. For example, the time is decreased between activation of a browser client feature (e.g., a hyperlink) and the browser client 304 executing a fetched resource (e.g., rendering a CSS file). For instance, the browser client 304 experiences an improved wait time at a queue of the browser client 304. In some implementations, the improved wait time at the queue is less than a wait time at a queue of a browser configured to receive only single, non-combined resources.

Note this method 300 may include other acts and/or details that are not discussed in this method overview. Other acts and/or details are discussed with reference to other figures and may be a part of the method 300, depending on the implementation. An act (e.g., computer act) may include one or more instructions. An instruction (e.g., computer instruction) may include a basic command of a computer and/or software application that directs one or more computers and/or one or more processors to perform one or more actions.

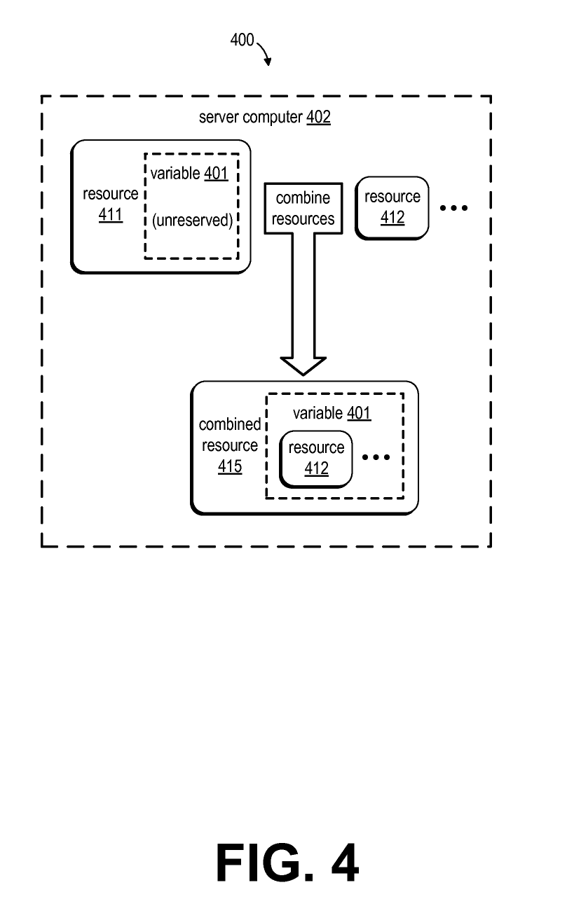

FIG. 4 is a schematic diagram of a method 400 for combining resources before sending the combined resource from a server computer to a browser client. The server computer 402 selects a variable 401 that is unreserved in a resource 411. For example, the server computer 402 selects a variable that is not already in use in a JavaScript™ file. Generally, the server computer 402 is configured to use any reasonable technique for avoiding a variable name collision in the resource 411. The server computer 402 generates a combined resource 415 by attaching (e.g., storing) at least one resource 412 to the variable 401 of the resource 411. For example, the server computer 402 stores at least one CSS file as text into a variable of a JavaScript™ file.

Other examples of resources combined at the server computer 402 include without limitation the following: a JavaScript™ file combined with at least one image file, an HTML document combined with at least one image, an HTML document combined with at least one style tag, and an HTML document combined with at least one CSS file.

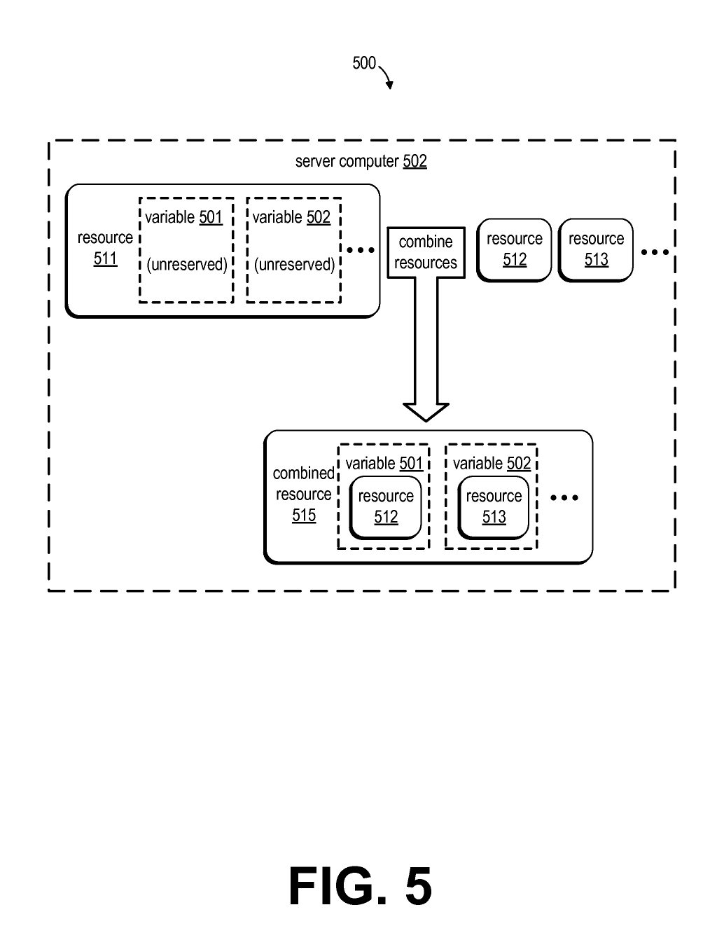

FIG. 5 is a schematic diagram of another method 500 for combining resources before sending the combined resource from a server computer to a browser client. The server computer 502 selects at least two variables that are unreserved in a resource 511. The unreserved variables here include at least a variable 501 and a variable 502. The server computer 502 generates a combined resource 515 by attaching (e.g., storing) the resource 512 to the variable 501 of the resource 511, and also attaching (e.g., storing) the resource 513 to the variable 502 of the resource 511. In this manner, the server computer 502 may continue to combine more resources into the combined resource 515.

In some implementations, the server computer 502 may combine resources by using a mix of the method 400 of FIG. 4 and the method 500 of FIG. 5. For example, the server computer 502 may store at least one resource in one variable of a JavaScript™ file, and also store multiple resources in another variable of the same JavaScript™ file.

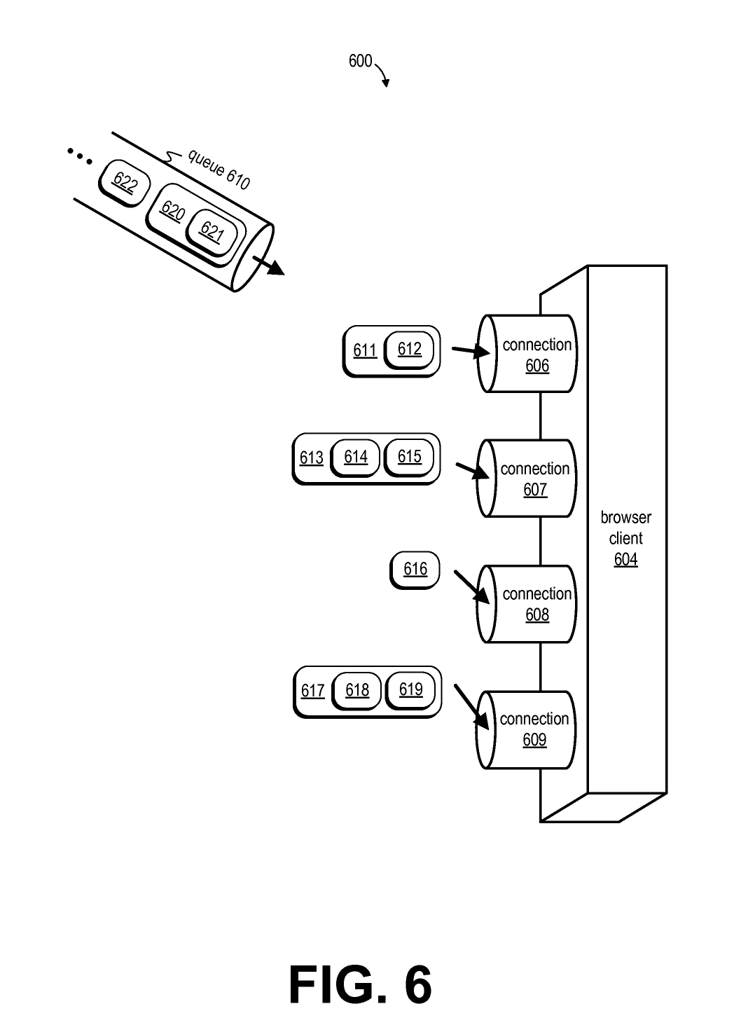

FIG. 6 is a conceptual diagram of a system 600 for serving combined resources from a server computer to a browser client 604. The browser client 604 is configured to receive only one combined resource, or one single resource, through one connection at one time. In this example, the browser client 604 has four connections that may receive resources in parallel. In another implementation, the browser client 604 may have more or fewer than four connections with a server.

A server (not shown) may send to the browser client 604 a combined resource 611 by way of a connection 606. The server may generate the combined resource 611, including a resource 612, by using the method 300 of FIG. 3. The server may also send to the browser client 604 a combined resource 613 (including a resource 614 and a resource 615) by way of a connection 607. The server may also send to the browser client 604 a resource 616, a single resource, by way of a connection 608. The server may also send to the browser client 604 a combined resource 617 (including a resource 618 and a resource 619) by way of a connection 609.

Accordingly, each connection 606, 607, 608 or 609, may receive a combined resource or a single resource. Each resource may be, for example, a JavaScript™ file or a CSS file.

The browser client 604 may have a limitation on the number of connections the browser client 604 may establish simultaneously. In this example, the browser client 604 has a limit of four connections that the browser client may establish at the same time. This limitation leads to the browser client 604 causing some resources to be placed into a queue 610 to wait to be executed. For example, the browser client 604 causes a combined resource 620 (including a resource 621) and a resource 622 to be placed in the queue 610. Fortunately, the system 600 is configured to operate around the limitations of the browser client 604 in order to push more resources through each connection at one time.

Once the browser client 604 receives a combined resource (e.g., combined resource 611) with an instruction set for processing the combined resource, the browser client 604 may begin executing resources in the combined resource before all the resources of the combined resource are completely downloaded. As described above with reference to FIG. 3, a combined resource may include, for example, a CSS file stored as text in a variable of a JavaScript™ file. The browser client 604 of FIG. 6 may include without limitation a JavaScript™ engine that is configured to interpret and/or execute the JavaScript™ of the combined resource 611.

Accordingly, the serving of the combined resource speeds up the user experience at the browser client 604. For example, the time is decreased between activation of a browser client feature (e.g., a hyperlink) and the browser client 604 executing a fetched resource (e.g., rendering a CSS file). For instance, the browser client 604 experiences an improved wait time at the queue 610 of the browser client 604. In some implementations, the improved wait time at the queue 610 is less than a wait time at a queue of a browser configured to receive only single, non-combined resources.

### Example Computer Implementation

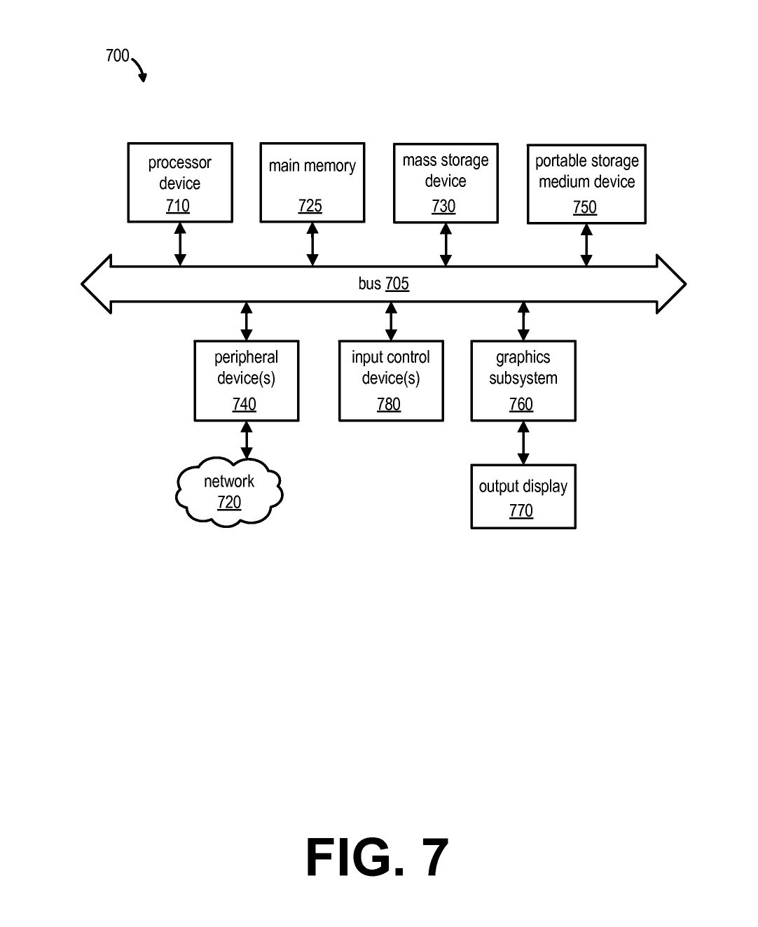

FIG. 7 is a block diagram of a general purpose or special purpose computer system 700. The computer system 700 may include, for example, a server, a client computer, a user device, and/or a user computer, among other things.

The computer system 700 preferably includes without limitation a processor device 710, a main memory 725, and an interconnect bus 705. The processor device 710 may include without limitation a single microprocessor, or may include a plurality of microprocessors for configuring the computer system 700 as a multi-processor system. The main memory 725 stores, among other things, instructions and/or data for execution by the processor device 710. If the system for generating a synthetic table of contents is partially implemented in software, the main memory 725 stores the executable code when in operation. The main memory 725 may include banks of dynamic random access memory (DRAM), as well as cache memory.

The computer system 700 may further include a mass storage device 730, peripheral device(s) 740, portable storage medium device(s) 750, input control device(s) 780, a graphics subsystem 760, and/or an output display 770. For explanatory purposes, all components in the computer system 700 are shown in FIG. 7 as being coupled via the bus 705. However, the computer system 700 is not so limited. Devices of the computer system 700 may be coupled through one or more data transport means. For example, the processor device 710 and/or the main memory 725 may be coupled via a local microprocessor bus. The mass storage device 730, peripheral device(s) 740, portable storage medium device(s) 750, and/or graphics subsystem 760 may be coupled via one or more input/output (I/O) buses. The mass storage device 740 is preferably a nonvolatile storage device for storing data and/or instructions for use by the processor device 710. The mass storage device 730, which may be implemented, for example, with a magnetic disk drive or an optical disk drive. In a software implementation, the mass storage device 730 is preferably configured to load contents of the mass storage device 730 into the main memory 725.

The portable storage medium device 750 operates in conjunction with a nonvolatile portable storage medium, such as, for example, a compact disc read only memory (CD ROM), to input and output data and code to and from the computer system 700. In some implementations, the software for generating a synthetic table of contents may be stored on a portable storage medium, and may be inputted into the computer system 700 via the portable storage medium device 750. The peripheral device(s) 740 may include any type of computer support device, such as, for example, an input/output (I/O) interface configured to add additional functionality to the computer system 700. For example, the peripheral device(s) 740 may include a network interface card for interfacing the computer system 700 with a network 720.

The input control device(s) 780 provide a portion of the user interface for a user of the computer system 700. The input control device(s) 780 may include a keypad and/or a cursor control device. The keypad may be configured to input alphanumeric and/or other key information. The cursor control device may include, for example, a mouse, a trackball, a stylus, a touchpad, and/or cursor direction keys. In order to display textual and graphical information, the computer system 700 preferably includes the graphics subsystem 760 and the output display 770. The output display 770 may include a cathode ray tube (CRT) display and/or a liquid crystal display (LCD). The graphics subsystem 760 receives textual and graphical information, and processes the information for output to the output display 770.

Each component of the computer system 700 may represent a broad category of a computer component of a general and/or special purpose computer. Components of the computer system 700 are not limited to the specific implementations provided here.

Portions of the present technology may be conveniently implemented by using a general purpose computer, a specialized digital computer and/or a microprocessor programmed according to the teachings of the present description, as will be apparent to those skilled in the computer art. Appropriate software coding may readily be prepared by skilled programmers based on the teachings of the present disclosure. Some implementations may also be implemented by the preparation of application-specific integrated circuits or by interconnecting an appropriate network of component circuits.

Some implementations include a computer program product. The computer program product may be a storage medium and/or media having instructions stored thereon and/or therein which can be used to control, or cause, a computer to perform any of the processes of the technology. The storage medium may include without limitation floppy disk, mini disk, optical disc, Blu-ray Disc, DVD, CD-ROM, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of device suitable for storing instructions and/or data.

Stored on any one of the computer-readable storage medium and/or media, some implementations include software for controlling both the hardware of the general and/or special computer or microprocessor, and for enabling the computer or microprocessor to interact with a human user or other mechanism utilizing the results of the technology. Such software may include without limitation device drivers, operating systems, and user applications. Ultimately, such computer-readable storage media further includes software for performing aspects of the technology, as described above.

Included in the programming and/or software of the general and/or special purpose computer or microprocessor are software modules for implementing the processes described above. The processes described above may include without limitation the following: retrieving, at the server computer, an individual document that includes multiple requests for resources, wherein the multiple requests include at least a request for a first resource and a request for a second resource; generating a modified individual document by using a server-generated Uniform Resource Locator (URL) to represent the multiple requests for resources in the individual document; sending, to the browser client, the modified individual document; receiving, from the browser client, a request matching the server-generated URL; generating a combined resource in response to receiving the request matching the server-generated URL, wherein the combined resource includes at least the first resource and the second resource; and sending, to the browser client, the combined resource.

### CONCLUSION

A technology is provided for serving a combined resource to a browser client. Advantageously, the present technology reduces the time between a browser client initially sending a request for a document and the browser client executing resources associated with the requested document. Thus, the method enables the system to speed up a user experience at a browser client.

In the foregoing specification, the technology has been described with reference to specific implementations thereof. It will, however, be evident that various modifications and changes may be made thereto without departing from the broader spirit and scope of the technology. The specification and drawings are, accordingly, to be regarded in an illustrative rather than a restrictive sense.

1. A method to facilitate serving resources from a server computer to a browser client, the method comprising:
retrieving, at the server computer, an individual document that includes multiple requests for resources, wherein the multiple requests include at least a request for a first resource and a request for a second resource;
generating a Uniform Resource Locator (URL) to represent the multiple requests for resources;
modifying the individual document to include the server-generated URL representing the multiple requests for resources;
sending, to the browser client, the modified individual document;
receiving, from the browser client, a request matching the server-generated URL;
generating a combined resource in response to receiving the request matching the server-generated URL, wherein the combined resource includes at least the first resource and the second resource; and
sending, to the browser client, the combined resource,
wherein the first resource comprises a file compatible with a scripting language that enables generating of dynamic and interactive Web pages, and the second resource comprises at least one Cascading Style Sheets file, such that the combined resource comprises at least the file compatible with the scripting language and the at least one Cascading Style Sheets file.

2. The method of claim 1, wherein generating the combined resource comprises:
selecting an unreserved variable of the first resource to be a selected variable of the first resource; and
attaching the second resource to the selected variable of the first resource.

3. The method of claim 1, further comprising, before generating the combined resource, retrieving the first resource and the second resource in response to receiving the request matching the server-generated URL.

4. (canceled)

5. The method of claim 1, wherein the combined resource enables a more efficient serving process than separately serving the first resource and the second resource, and wherein the combined resource decreases a wait time at a queue of the browser client.

6. The method of claim 1, wherein the second resource is executable at the browser client before the server computer completely sends the first resource.

7. The method of claim 1, wherein generating a combined resource includes incorporating instructions causing the browser client to remove second Cascading Style Sheets file from a variable of the first resource and then apply the second Cascading Style Sheets file to a Document Object Module of the modified individual document.

8. The method of claim 1, the first resource further including at least
a Hypertext Transfer Markup Language file.

9. The method of claim 1, the second resource further including at least one of
a style tag; or an image file.

10. The method of claim 1, wherein generating the combined resource and the instruction set occur before receiving the request matching the server-generated URL.

11. The method of claim 1, wherein the server computer is configured to communicate with the browser client via four or less Hypertext Transfer Protocol connections and to send only one combined resource through one Hypertext Transfer Protocol connection at one time.

12. A server computer to facilitate serving resources to a browser client, the server computer comprising:
one or more processors; and
a machine-readable medium comprising instructions stored therein, which when executed by the processors, cause the processors to perform operations comprising:
retrieving an individual document that includes multiple requests for resources, wherein the multiple requests include at least a request for a first resource and a request for a second resource;
generating a Uniform Resource Locator (URL) to represent the multiple requests for resources;
modifying the individual document to include the server-generated URL representing the multiple requests for resources;
sending, to the browser client, the modified individual document;
receiving, from the browser client, a request matching the server-generated URL; and
generating a combined resource in response to receiving the request matching the server-generated URL, wherein the combined resource includes at least the first resource and the second resource, wherein the sender device is further configured to send, to the browser client, the combined resource, and
wherein the first resource comprises a file compatible with a scripting language that enables generating of dynamic and interactive Web pages, and the second resource comprises at least one Cascading Style Sheets file, such that the combined resource comprises at least the file compatible with the scripting language and the at least one Cascading Style Sheets file.

13. The server computer of claim 12, the operations further comprising:
selecting an unreserved variable of the first resource to be a selected variable of the first resource; and
attaching the second resource to the selected variable of the first resource.

14. The server computer of claim 12, wherein the retrieving further comprises retrieving the first resource and the second resource in response to receiving the request matching the server-generated URL.

15. (canceled)

16. The server computer of claim 12, wherein the combined resource enables a more efficient serving process than separately serving the first resource and the second resource, and wherein the combined resource decreases a wait time at a queue of the browser client.

17. The server computer of claim 12, wherein the second resource is executable at the browser client before the server computer completely sends the first resource.

18. The server computer of claim 12, wherein the generating further comprises incorporating instructions with the combined resource, and wherein the instructions cause the browser client to remove second Cascading Style Sheets file from a variable of the first resource and then apply the second Cascading Style Sheets file to a Document Object Module of the modified individual document.

19. One or more non-transitory computer-readable storage media storing instructions that when executed cause one or more processors to perform a process, the process comprising:
retrieving, at the server computer, an individual document that includes multiple requests for resources, wherein the multiple requests include at least a request for a first resource and a request for a second resource;
generating a Uniform Resource Locator (URL) to represent the multiple requests for resources;
modifying the individual document to include the server-generated URL representing the multiple requests for resources;
sending, to the browser client, the modified individual document;
receiving, from the browser client, a request matching the server-generated URL;
generating a combined resource in response to receiving the request matching the server-generated URL, wherein the combined resource includes at least the first resource and the second resource; and
sending, to the browser client, the combined resource,
wherein the first resource comprises a file compatible with a scripting language that enables generating of dynamic and interactive Web pages, and the second resource comprises at least one Cascading Style Sheets file, such that the combined resource comprises at least the file compatible with the scripting language and the at least one Cascading Style Sheets file.

20. The one or more non-transitory computer-readable storage media of claim 19, wherein generating the combined resource comprises:
selecting an unreserved variable of the first resource to be a selected variable of the first resource; and
attaching the second resource to the selected variable of the first resource.
